(19) United States
(12) Patent Application Publication
(10) Pub. No.: US 2002/0173264 A1
(43) Pub. Date: Nov. 21, 2002

(54) Rear ventilation system for vehicle

(76) Inventors: Thomas C. Ottman, Oxford, MI (US); Harry Eriksson, Trollhattan (SE)

Correspondence Address: DAVID S. BIR, Brooks & Kushman P.C., 22nd Floor, 1000 Town Center, Southfield, MI, 48075-1351, US

(21) Appl. No.: 09/997,632

(22) Filed: Nov. 29, 2001

Related U.S. Application Data
(60) Provisional application No. 60/253,893, filed on Nov. 29, 2000.

(51) Int. Cl. B60H 1/00; B60H 1/26

(52) U.S. Cl. 454/142

(57) ABSTRACT

A rear ventilation system for a vehicle includes an air intake pump having a blower disposed within the housing to generate a forced flow of air into a thermal control. The thermal control includes a set of passages which direct air toward a heating and cooling core. The heating and cooling core includes a plurality of thermoelectric element units in communication with a direct current (DC) power supply disposed between a pair of heat exchangers. The plurality of thermoelectric element units absorb or generate heat employing the Peltier effect. The tempered air is delivered to at least one duct extending from the thermal control into the interior of the rear portion of the passenger compartment. A vent outlet in communication with the at least one duct extends into the rear passenger compartment to distribute air from the rear ventilation system.

### CROSS-REFERENCE TO RELATED APPLICATIONS

This application claims the benefit of U.S. provisional application Serial No. 60/253,893, filed Nov. 29, 2000, the disclosure of which is incorporated by reference in its entirety.

### FIELD OF THE INVENTION

The present invention relates to a rear ventilation system for a vehicle and more particularly, to a rear ventilation system for a vehicle incorporating Peltier technology.

### BACKGROUND ART

Climate control systems, such as heating ventilation and air conditioning (HVAC) systems are provided in automotive vehicles to maintain a comfortable environment within the passenger compartment of the vehicle. Vehicle HVAC systems generally include ducts for supplying air to the passenger compartment, a blower disposed within the engine compartment which forces air through the ducting, a heating supply for heating the air, a cooling supply for cooling the air and a series of vents provided in the instrument panel of the vehicle to introduce air from the ducts into the passenger compartment. A set of controls in the instrument panel allows passengers to adjust the temperature and flow rate of air from the HVAC system into the passenger compartment.

One of the problems associated with common HVAC systems is that passengers in the rear of the passenger compartment do not receive adequate ventilation from the vents in the instrument panel in the front of the passenger compartment. One solution is to run ducts from the engine compartment through either door panels, the headliner, or the center console of the passenger compartment to the rear of the passenger compartment of the vehicle to provide ventilation. This ventilation arrangement increases the cost and complexity of manufacturing the vehicle to include ducts for the HVAC system. Also, additional blowers and other parts must be coupled to the ducts extending to the rear of the passenger compartment to provide sufficient air flow to the passengers in the rear of the vehicle. Finally, it is difficult to maintain the temperature of the air from the heating or cooling supply to the rear of the vehicle without providing additional heating and/or cooling supplies on the ducts.

Current air conditioning modules of HVAC systems use a vapor compression system which includes a compressor unit driven by the vehicle engine. A problem with this arrangement is that a significant percentage of fuel used by the engine to power the vehicle is used to support and sustain the vehicle heating and cooling systems, decreasing overall fuel efficiency of the vehicle. Additionally, HVAC systems use a large amount of compressed gases to provide cooling for the HVAC ventilation system, increasing the costs of maintaining the vehicle HVAC system.

It is therefore desirable to eliminate the problems associated with the heating and cooling of the rear passenger compartment of a vehicle in the design, manufacture and operation of vehicle HVAC systems. It is also desirable to provide a rear ventilation system for a vehicle which eliminates the use of compressed vapor systems.

### SUMMARY OF THE INVENTION

The present invention overcomes the above referenced problems associated with prior climate control systems by providing a heating ventilation and air conditioning system having a front ventilation system disposed in an engine compartment of a vehicle and a rear ventilation system independent of the front ventilation system. The rear heating ventilation and air condition (HVAC) system comprises an air intake pump mounted in the trunk of the vehicle. The air intake pump includes a housing having a blower disposed within a cavity in the housing. The blower draws air from the trunk and generates a forced flow of air into a thermal control section in communication with the air intake pump. A control flap is selectively positionable to restrict and direct the flow of air into a set of passages in the thermal control section.

The thermal control section of the rear ventilation system includes a set of passages which direct air entering the thermal control section from the air intake pump blower. A lower passage in the thermal control section includes an outlet port which expels exhaust air from the thermal control section through the outlet port into the trunk of the vehicle. The upper passage in the thermal control section supplies the tempered or conditioned air from the air intake pump to at least one duct of the rear ventilation system after passing through a heating and cooling core.

The heating and cooling core, disposed between the passages in the thermal control section housing, treats air forced through by the air intake pump. The heating and cooling core includes a plurality of thermoelectric element units in communication with a direct current (DC) power supply disposed between a pair of heat exchangers. The plurality of thermoelectric element units will either absorb heat or generate heat, employing the Peltier effect to heat or cool the air, based on the polarity of the current flowing through the elements, transferring the heat absorbed or generated through the heat exchangers for delivery to the rear passenger compartment.

At least one duct extends from the thermal control section into the interior of the passenger compartment. A vent outlet in communication with the at least one duct extends into the rear passenger compartment to distribute air from the rear ventilation system. The vent outlets are provided at various locations in the rear passenger compartment to provide a number of climate control zones. Each climate control zone includes controls provided in the rear passenger compartment to adjust the temperature and flow of air into the compartment from each of the vent outlets.

The present invention provides a number of advantages. For example, the present invention provides a heating ventilation and air conditioning system for a vehicle including a rear ventilation system, independent of the front heating ventilation and air conditioning system, incorporating Peltier technology to provide heating and cooling for the rear passenger compartment of the vehicle with reduced manufacturing costs and increased fuel efficiency. The present invention also provides a rear ventilation system for a vehicle having multiple climate zones to increase the level of comfort for passengers in the rear passenger compartment of the vehicle.

The above advantages and other objects, features and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic view of the rear ventilation system of the present invention;

FIG. 2 is a schematic representation of a combination of thermoelectric elements of the heating and cooling core of the rear ventilation system of the present invention;

FIG. 3 is a schematic representation of the thermoelectric elements of the heating and cooling core of the rear ventilation system in the air conditioning mode;

FIG. 4 is a schematic representation of the thermoelectric elements of the heating and cooling core of the rear ventilation system in the heater mode;

FIG. 5 is an exploded perspective view of the thermoelectric elements of the heating and cooling core of the rear ventilation system of the present invention;

FIG. 6 is a schematic view of the rear ventilation system of the present invention in combination with the front ventilation system in heater mode; and

FIG. 7 is a schematic view of the rear ventilation system of the present invention in combination with the front ventilation system in air conditioning mode.

### DETAILED DESCRIPTION OF THE PREFERRED EMBODIMENT(S)

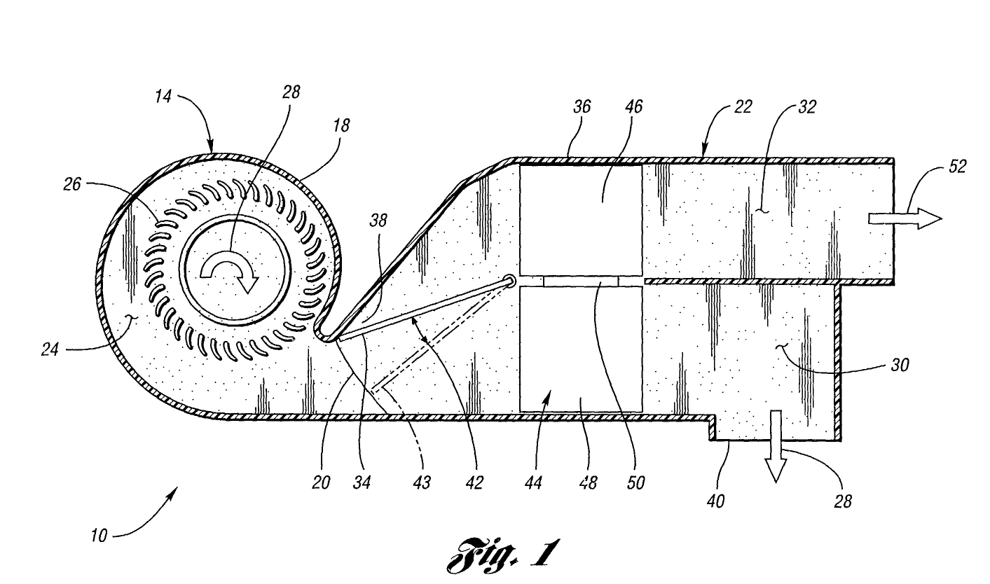

Referring now to FIG. 1, a rear heating ventilation and air condition (HVAC) system 10 is disposed in the rear of the vehicle 12 (FIGS. 6, 7). Rear ventilation system 10 comprises an air intake pump 14 mounted in the trunk 16 of the vehicle 12. The air intake pump 14 includes a housing 18 having a first end 20 in communication with a thermal control section 22. Housing 18 of air intake pump 14 includes a cavity 24 having a blower 26 disposed therein. Blower 26 draws air, represented by arrow 28, from the trunk 16 into air intake pump 14 through an air inlet port (not shown). Blower 26 forces air 28 through cavity 24 into thermal control section 22 of rear ventilation system 10.

Thermal control section 22 of rear ventilation system 10 includes a pair of passages 30, 32 which separate and direct air generated by blower 26. A control flap 34 is pivotally mounted to the housing 36 of thermal control section 22. An opening 38 in thermal control section 22 corresponds to the first end 20 of housing 18 of air intake pump 14. Control flap 34 is selectively positionable adjacent opening 38 to direct the flow of air 28 from air intake pump 14.

As shown in FIG. 1, control flap 34 is positioned to restrict air flow into upper passage 32, directing the air 28 downstream through lower passage 30 towards air outlet port 40. Alternatively, control flap 34 may be positioned adjacent housing portion 42 to allow air 28 to flow into upper passage 32 along heating and cooling core 44 as represented by reference numeral 43. Heating and cooling core 44 is disposed within housing 36 of thermal control section 22 between upper and lower passages 30, 32 to condition air 28 entering from air intake pump 14.

Heating and cooling core 44 includes an upper heat exchanger 46 disposed in upper passage 32 of thermal control section 22 and a lower heat exchanger 48 disposed in lower passage 30. A plurality of thermoelectric element units 50 are disposed between upper and lower heat exchangers 46, 48. Thermoelectric elements 50 generate or absorb heat based on the Peltier effect which is communicated to heat exchangers 46, 48. Heat exchangers 46, 48 transfer or exchange heat generated by thermoelectric elements 50 to air 28 from air intake pump 14 to condition exiting air 52 from thermal control section 22.

Referring now to FIGS. 2-5, thermoelectric elements 50 of heating and cooling core 44 are described in greater detail. The thermoelectric elements are used in place of compressed vapor systems to generate or absorb heat to heat and cool the passenger compartment of the vehicle. Thermoelectric elements 50 generally include a semiconductor 54 soldered between electrically conductive connectors 56. In a preferred embodiment of the invention, semiconductor 54 is soldered between plated copper connectors which are connected to a direct current power supply 58 by connection paths 60.

Thermoelectric elements 50 generate and absorb heat by the Peltier effect, which occurs when electrical current flows through two dissimilar conductors. The junctions between the semiconductor 54 and the electrically conductive connectors 56 will absorb or release heat based on the direction of current flow through elements 50. As is shown in FIG. 2, a “P” type semiconductor 54 is manufactured so that the charge carriers in semiconductor 54 are positive. Thus, when current 62 is applied to semiconductor 54 by power supply 58, the charge carriers are repelled by the positive pole of power supply 58, forcing the charge carriers toward the negative pole of power supply 58. This interaction causes heat to be moved in the direction of the charge carriers, thus causing heat to be absorbed through the upper connector 56 and released through the lower connector, represented by numeral 64.

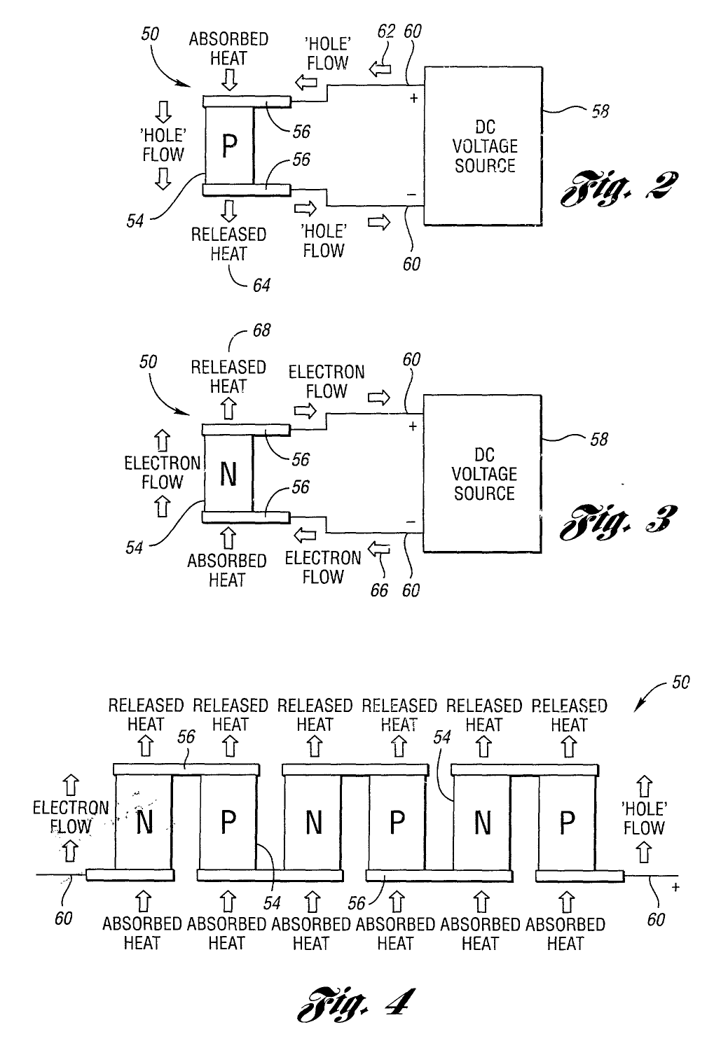

Alternatively, as shown in FIG. 3, an “N” type semiconductor contains electrons which act as charge carriers in the thermoelectric element system 50. When power supply 58 applies a current 66 to the system, electrons are repelled by the negative pole of the power supply, forcing the electron charge carriers through the semiconductor 54 toward the positive pole of power supply 58 connected to upper connector 56. Thus, heat is absorbed through lower connector 56 and is released, represented by numeral 68, through upper connector 56.

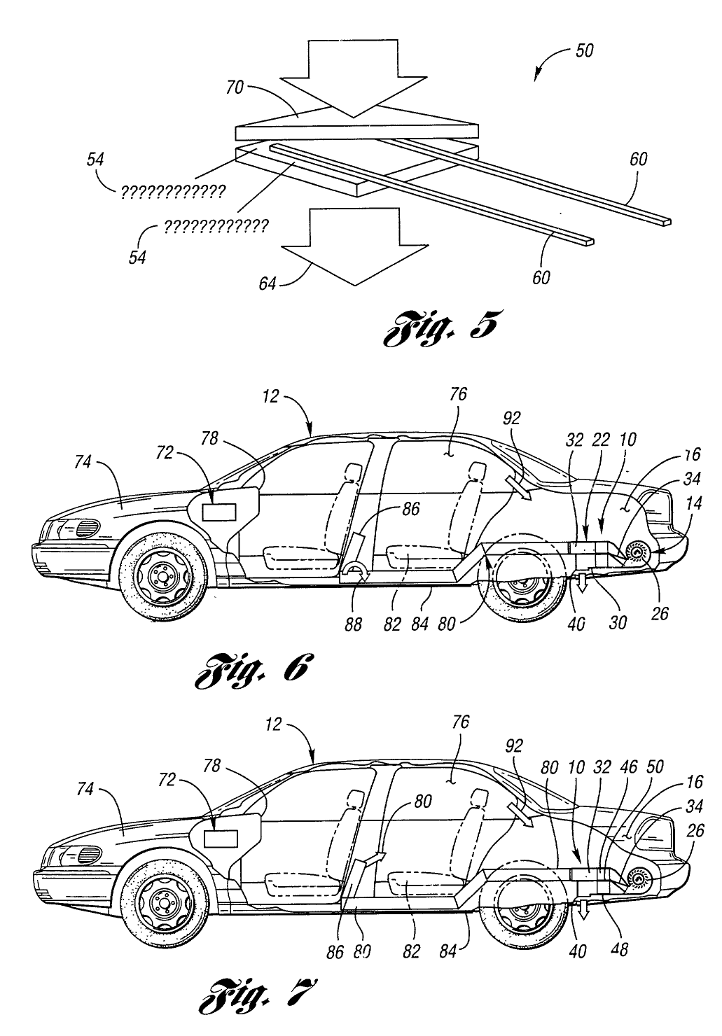

Referring now to FIGS. 4 and 5, a representation of the “N” type and “P” type semiconductors 54 of thermoelectric elements 50 is shown. The semiconductors 54 are arranged electrically in series to decrease the amount of connections for each type of semiconductor, while arranged thermally in parallel to ensure that heat will be generated or absorbed in the same direction. Additionally, the semiconductor array maximizes the flow of current from the voltage supply through the system to reduce the overall power requirements for the thermoelectric elements 50 of heating and cooling core 44 of rear ventilation system 10. To create the multiple semiconductor arrays, a ceramic substrate 70 is mounted to the connectors 56. The ceramic substrate conducts heat from the semiconductor array of thermoelectric elements 50 to heat exchangers 46, 48. Heat exchangers 46, 48 thereby condition air 28 from blower 26 prior to introducing the air to the rear passenger compartment of vehicle 12.

Referring now to FIGS. 6 and 7, a schematic representation of the rear ventilation system of the present invention is described in greater detail. A front ventilation system, generally shown as block 72, is disposed in an engine compartment 74 of vehicle 12. Generally, front ventilation system 72 includes a plurality of ducts for supplying air to a passenger compartment 76 of vehicle 12 and a blower (not shown) disposed within the engine compartment which forces air through the plurality of ducts.

The front ventilation system may additionally include a heating supply and a cooling supply in communication with the blower for adjusting the temperature of the air flowing through the plurality of ducts. Each duct is in communication with a vent provided in an instrument panel 78 of vehicle 12 to introduce air into passenger compartment 76. A set of controls is disposed within passenger compartment 76 to adjust the temperature and flow rate of air from front ventilation system 72 into the front of the passenger compartment of vehicle 12.

Rear ventilation system 10 is disposed in trunk 16 of vehicle 12. Blower 26 of air intake pump 12 draws air 28 from inside the trunk area and forces the air into thermal control section 22. In the heater mode shown in FIG. 6, control flap 34 directs the majority of air from blower 26 through upper passage 32. Thermoelectric elements 50 of heating and cooling core are polarized to release heat into upper heat exchanger 46. The upper heat exchanger tempers or conditions air from blower 26 prior to distributing tempered air 52 into at least one interconnected duct 80. Some air from blower 26 also flows through lower passage 30 and is conditioned by lower heat exchanger 48 prior to being discharged through air outlet port 40.

The at least one duct 80 of rear ventilation system 10 extends from thermal control section 22 into the interior of passenger compartment 76. In a preferred embodiment of the invention, ducts 80 extend below seats 82 and the floor of passenger compartment 76 along an upper surface of the vehicle undercarriage 84. A vent outlet 86 extends into the rear portion of passenger compartment 76 to distribute tempered air 52 from the rear ventilation system 10. Preferably, a series of vent outlets 86 extend into the rear portion of passenger compartment 76 to provide multiple heating and cooling zones in the compartment.

Controls are provided in the rear portion of passenger compartment 76 of vehicle 12 to allow passengers to control the temperature and flow of air into the compartment. In the heater mode, tempered air 88 from rear ventilation system 10 exits vent outlet 86 along the floor of passenger compartment 76 to heat or cool the rear area of vehicle 12. However, as is seen in the air conditioning mode shown in FIG. 7, tempered air 90 from rear ventilation system 10 may exit through vent outlets 86 above floor level to heat or cool passenger compartment 76.

In an alternative embodiment of the invention, rear ventilation system 10 includes a plurality of ducts 80 extending from thermal control section 22 to various locations in the rear passenger compartment 76 to provide a multiple zone climate control system. Controls are provided in the rear portion of passenger compartment 76 at each zone location to adjust the temperature and flow of air into the compartment from each of the vent outlets 86. Air 92 from passenger compartment 76 is drawn through vents (not shown) in the passenger compartment into the trunk 16 to remove tempered air from the compartment and to circulate air to the blower 26 for use in the rear ventilation system 10.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A rear ventilation system for a vehicle, the ventilation system comprising:
an air pump disposed in a trunk of the vehicle, the air intake pump having an air intake passage and a pump housing including a blower mounted within a cavity of the housing to generate a forced air flow through an air outlet;
a thermal control in communication with the air outlet of the air intake pump via an air inlet portion connected to the air outlet of the intake pump, the thermal control including at least one passage that receives the forced air flow from the blower, and an outlet passage; and
a heating and cooling core disposed within the thermal control conditioning the forced air flow from the air intake pump, the heating and cooling core including at least two heat exchangers and a plurality of thermoelectric element units disposed between the heat exchangers, wherein the plurality of thermoelectric element units condition the air based on polarity of current flowing through the elements.

2. The system of claim 1 wherein the plurality of thermoelectric element units of the heating and cooling core are arranged electrically in series and thermally in parallel.

3. The system of claim 1 further comprising:
at least one duct operatively connected to the outlet passage of the thermal control to supply conditioned forced air flow to a passenger compartment of the vehicle.

4. The system of claim 3 further comprising:
at least one vent outlet in communication with the at least one duct to distribute conditioned air from the thermal control to the passenger compartment to adjust the temperature and flow of air into the compartment.

5. The system of claim 1 further comprising:
at least one duct fluidly coupling the trunk of the vehicle to a passenger compartment to remove air from the passenger compartment for use by the blower in the rear ventilation system.

6. The system of claim 1 wherein the thermal control comprises:
upper and lower passages in fluid communication with the air outlet of the air intake pump, wherein the upper passage communicates conditioned air to a passenger compartment of the vehicle and the lower passage vents air outside of the vehicle.

7. The system of claim 6 wherein the inlet portion of the thermal control includes a diverter for directing a portion of the air from the intake pump to the lower passage.

8. The system of claim 1 wherein the at least one passage of the thermal control includes an upper passage and a lower passage, the system further comprising:
a selectively positionable control flap mounted adjacent the air inlet portion of the thermal control to selectively direct substantially all of the forced air flow from the air intake pump into the lower passage for venting outside of the vehicle.

9. The system of claim 1 further comprising:
at least one control interface positioned within a rear portion of the passenger compartment of the vehicle for controlling current delivered to the plurality of thermoelectric element units of the heating and cooling core.

10. A ventilation system for a vehicle having a passenger compartment and a trunk, the ventilation system comprising:
an air intake pump having a blower for pumping air from an air intake passage in fluid communication with the trunk of the vehicle to generate a forced air flow through an air outlet for the passenger compartment of the vehicle;
a thermal control in communication with the air outlet of the air intake pump via an air inlet portion connected to the air outlet of the intake pump, the thermal control including at least one passage that directs the forced air flow from the blower to a heating and cooling core disposed within the thermal control for conditioning the forced air flow from the air intake pump, the heating and cooling core including at least two heat exchangers and a plurality of thermoelectric element units disposed between the heat exchangers, wherein the plurality of thermoelectric element units condition the air based on polarity of current flowing through the elements; and
at least one duct operatively connected to the thermal control to supply conditioned forced air flow to the passenger compartment of the vehicle.

11. The system of claim 10 wherein the plurality of thermoelectric element units of the heating and cooling core are arranged electrically in series and thermally in parallel.

12. The system of claim 10 wherein the thermal control comprises:
an upper passage and a lower passage in fluid communication with the air outlet of the air intake pump, wherein the upper passage communicates conditioned air to the passenger compartment of the vehicle and the lower passage vents air outside of the vehicle.

13. The system of claim 12 further comprising:
a controllable diverter disposed within the thermal control to selectively divert air from the air intake pump to the lower passage to prevent cold air from being delivered to the passenger compartment when the thermal control is in the heating mode.

14. The system of claim 13 further comprising:
at least one duct for fluidly coupling the trunk of the vehicle to a passenger compartment to remove air from the passenger compartment for use by the blower of the intake air pump.

15. The system of claim 10 further comprising:
at least one control interface disposed within a rear portion of the passenger compartment for controlling current delivered to the plurality of thermoelectric elements of the heating and cooling core.

16. The system of claim 10 wherein the air pump, thermal control, and at least one duct are independent of a front ventilation system for conditioning air for a front portion of the passenger compartment of the vehicle.

17. The system of claim 10 further comprising:
an independent front ventilation system disposed within an engine compartment of the vehicle for providing conditioned air to a front portion of the passenger compartment of the vehicle.

18. A method for providing heating, cooling, and ventilation to a rear portion of a passenger compartment of a vehicle having a trunk, the method comprising:
selectively pumping air from the trunk through a thermal control having a heating and cooling core including a plurality of thermoelectric elements arranged electrically in series and thermally in parallel to condition the air in response to an applied current; and
routing the air from the thermal control to the rear portion of the passenger compartment to provide heating, cooling, and ventilation to the rear portion of the passenger compartment.

19. The method of claim 18 wherein the step of selectively pumping air comprises:
extracting air from the passenger compartment through the trunk; and
pumping the extracted air to an exterior of the vehicle.

20. The method of claim 18 further comprising:
controlling current delivered to the plurality of thermoelectric elements from the rear portion of the passenger compartment of the vehicle.

21. The method of claim 18 further comprising:
routing a portion of the air pumped from the trunk through the thermal control and to an exterior of the vehicle to cool the plurality of thermoelectric elements.

22. The method of claim 18 wherein the step of routing comprises routing the air below a vehicle floor and above a vehicle underbody to the rear portion of the passenger compartment.

23. The method of claim 18 further comprising:
conditioning air for a front portion of the passenger compartment using an independent heating, cooling, and ventilation system.
